(19) United States
(12) Patent Application Publication
(10) Pub. No.: US 2009/0301858 A1
(43) Pub. Date: Dec. 10, 2009

(54) Piston holder for pressure switch assembly

(76) Inventors: Samuel Roland Palfenier, El Paso, TX (US); Raul Buendia, Cd. Juarez (MX)

Correspondence Address: DELPHI TECHNOLOGIES, INC., M/C 480-410-202, PO BOX 5052, TROY, MI, 48007, US

(21) Appl. No.: 12/156,873

(22) Filed: Jun. 5, 2008

(51) Int. Cl. H01H 35/26; F16J 1/00

(52) U.S. Cl. 200/83 J; 92/208; 92/98 R

(57) ABSTRACT

A piston holder for a vehicle sensor including a diaphragm deflectable under fluid pressure to move a piston includes a unitary body that in turn defines a cylindrical outer body portion configured for surrounding the piston. The body has an open upper end circumscribed by an outwardly-flared flange and a rounded annular elbow opposite the flange for contacting the diaphragm. An annular skirt extends from the elbow. The skirt includes a first portion oriented radially inwardly and upwardly at an oblique angle to the vertical dimension defined by the outer body portion. An inner bump is formed in the first portion for establishing a contact point with the diaphragm when the holder is deformed, and a second portion extends from the first portion and is oriented parallel to the axial dimension for engaging a channel of the piston.

### FIELD OF THE INVENTION

The present invention relates generally to pressure switches, and more particularly to piston holders in pressure switches for vehicles.

### BACKGROUND OF THE INVENTION

Pressure switch manifolds, which are one non-limiting environment to which the present invention applies, are used in automotive transmission applications for direct sensing of fluid pressure. Applications include hydraulic feedback gear selection, shift timing/feel control, torque converter clutch control, solenoid feedback control, solenoid fault detection, and improved idle control.

As understood herein, hydraulic pressure deflects or moves a diaphragm against a spring loaded piston in some pressure switch designs. The design can be of the contact type, wherein piston movement creates a short circuit condition that closes a contacting switch at a predefined hydraulic pressure and associated piston position, or the design can be contactless, in which case piston motion is sensed by a sensor such as a Hall sensor which outputs a signal at a predetermined piston position (and, hence, pressure).

In either case, the piston can be surroundingly supported by a holder, a portion of which rests on the diaphragm. As understood herein, the holder may exhibit excessive plastic deformation during assembly. The present invention recognizes that this in turn undesirably can affect diaphragm sealing and piston travel distance, and, thus, undesirably affect the piston position at which the switch generates the intended signal, leading to inaccurate pressure switch output.

### SUMMARY OF THE INVENTION

A piston holder for a vehicle sensor which includes a diaphragm deflectable under fluid pressure to move a piston includes a unitary body that in turn defines a cylindrical outer body portion configured for surrounding the piston. The body has an open upper end circumscribed by an outwardly-flared flange and a rounded annular elbow opposite the flange for contacting the diaphragm. An annular skirt extends from the elbow. The skirt includes a first portion oriented radially inwardly and upwardly at an oblique angle to the vertical dimension defined by the outer body portion. An inner bump is formed in the first portion for establishing a contact point with the diaphragm when the holder is deformed, and a second portion extends from the first portion and is oriented vertically (parallel to the axial dimension) for engaging a channel of the piston.

In another aspect, a pressure switch assembly includes a housing disposable in a fluid, and an opening is in the housing and is in fluid communication with the fluid when the housing is disposed therein. A diaphragm is juxtaposed with the opening and is deflectable by fluid pressure. A piston is disposed adjacent the diaphragm with a spring urging the piston toward the opening. A holder supports the piston and is formed with an elbow resting on the diaphragm. The holder is formed with an annular skirt at least a portion of which extends radially inwardly and upwardly from a bottom rounded elbow of the holder, with the elbow establishing a primary contact point with the diaphragm. Also, a convexity is formed in the skirt to establish a secondary contact point with the diaphragm when the holder is slightly deformed during assembly.

In some embodiments the skirt is formed with a substantially vertical upper segment extending from the portion of the skirt which extends radially inwardly and upwardly from the elbow. The upper segment mates with an annular channel of the piston. The holder may also define an upper outwardly-flared flange. If desired, an inside surface of the portion of the skirt which angles radially inwardly and upwardly can establish a stop against which a part of the piston rests. The convexity may be closer to the upper flange than is the elbow in the axial dimension defined by the annular skirt. Owing to the flared configuration of the upper flange and stronger, less deformable configuration afforded by the elbow and angled orientation of the skirt with convexity, substantially more assembly tolerances are absorbed by the flange than the portion of the skirt which extends radially inwardly and upwardly from the elbow.

In another aspect, a piston holder is formed from a unitary deformable body that, in an undeformed state, includes an open upper component configured for absorbing axial tolerance during assembly. The body also includes an outer generally cylindrical body component extending down from the upper component and a radially inner skirt. A first rounded contact point with a surface is established between the outer generally cylindrical body component and skirt. The skirt is additionally formed with a second rounded contact point oriented closer in an axial dimension defined by the cylindrical body component to the open upper component than is the first contact point. The body is deformable to cause both contact points to contact the surface simultaneously.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of the piston holder in an example pressure switch environment, including a schematic rendering of a switch and engine control module (ECM);

FIG. 2 is perspective view of an example embodiment of the holder; and

FIG. 3 is a side elevational view of the piston holder in the pressure switch environment, showing only the holder in cross-section for clarity and with the holder bumps in their uncompressed configuration shown overlapping the diaphragm for illustration only, and, since the assembly is symmetric about the vertical axis, with most of the right half of the assembly cut away for clarity.

### DETAILED DESCRIPTION OF THE PREFERRED EMBODIMENT

The present invention may be used but is not limited to an automotive transmission pressure switch. Terms of direction (such as “upper” and “lower”) used herein are not absolute but relative to the orientation of the components shown in figures looking down on the figures; thus for example, in implementation the invention may be turned upside down from the orientation shown in the figures, depending on the application, without establishing a reversal of direction thereby.

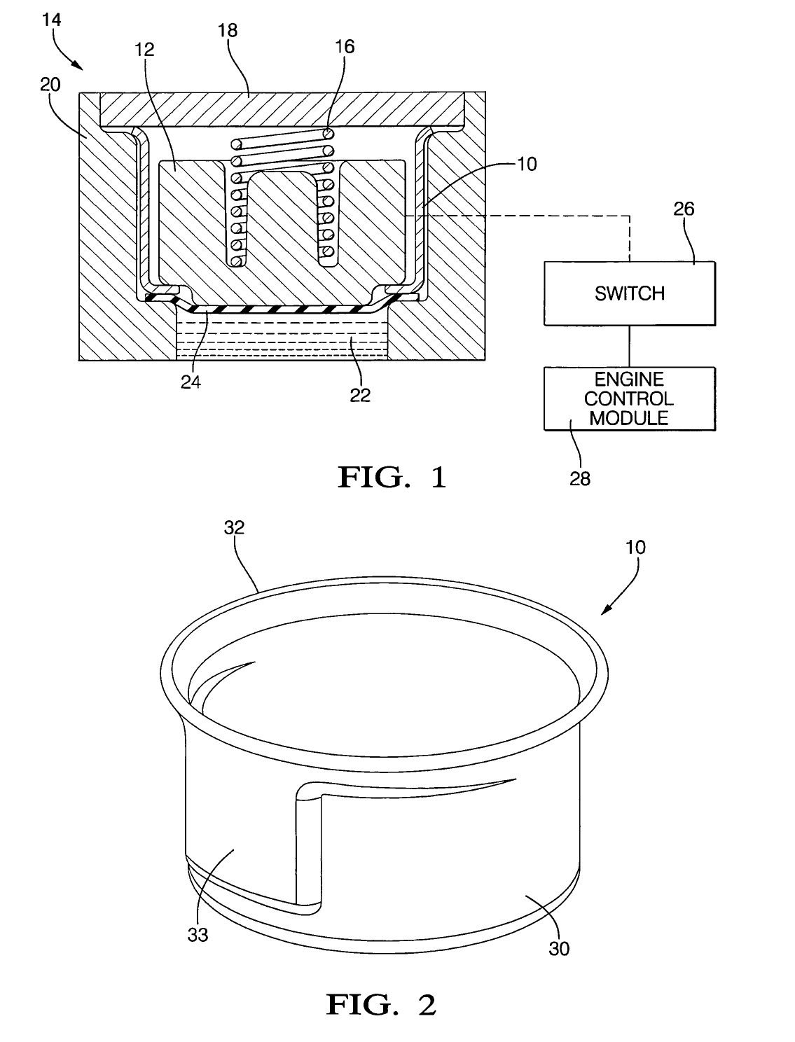

FIG. 1 schematically shows a piston holder 10 that surroundingly engages a piston 12 of a pressure switch assembly, generally designated 14. The piston 12 is urged down in FIG. 1 by a compression spring 16 disposed between the piston 12 and a cover 18 of a housing 20, while fluid pressure at an opening 22 of the housing 20 can deflect a diaphragm 24 that is in contact with the piston 12, so that deflection of the diaphragm 24 moves the piston 12 up in FIG. 1, typically although not exclusively when fluid pressure under the diaphragm 24 reaches a threshold at which it is desired to generate a signal.

As shown in FIG. 1, the piston 12 is magnetically or mechanically or otherwise coupled to a switch 26. The switch 26 outputs a signal, typically although not exclusively when the piston 12 is moved to a threshold position by the diaphragm 24. In turn, the output of the switch 26 may be sent to a processor such as but not limited to an engine control module 28 for control of a vehicle component in response to the signal from the switch.

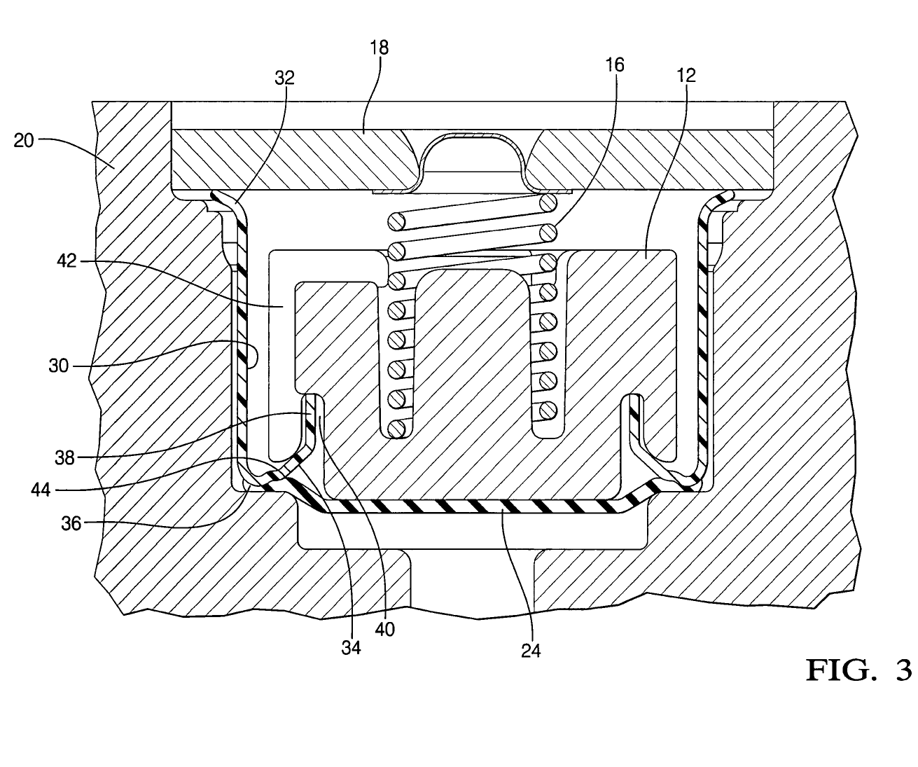

FIG. 2 shows that an example holder 10 includes a plastic or rubber generally cylindrical unitary hollow body 30 configured for surrounding the piston 12. The upper end of the body 30 is circumscribed by an integral outwardly-flared flange 32 which is molded in the flared configuration shown, such that upon release of any deforming force on the flange 32, the material bias of the flange 32 returns it to the flared configuration shown. As will be described further below in reference to FIG. 3, the bottom of body 30 is also open. One or more strengthening features such as axially-oriented ribs 33 may be provided on the body 30.

FIG. 3 shows additional details of the holder 10. As shown, at the bottom of the body 30 (i.e., the end opposite the flared flange 32), the body 30 is formed with an annular skirt 34 a lower portion of which extends radially inwardly and upwardly from a bottom rounded elbow 36. An upper segment 38 of the skirt 34 may be substantially vertical as shown, i.e., parallel to and coaxial with the outer surface of the body 30 shown in FIG. 2, such that the upper segment 38 mates with an annular channel 40 of the piston 12.

Focusing on the lower portion of the skirt 34, i.e., the portion that extends radially inwardly and upwardly from the bottom elbow 36, it may readily be appreciated that the lower end of an outer body portion 42 of the piston 12 rests on the surface of the skirt 34 that faces the outer portion of the body 30 of the holder 10. In effect, the lower portion of the skirt 34 functions as a piston stop, in that owing to the upward and radially inward configuration of the skirt 34 lower portion (and to some extent the fact that the end of the vertical upper segment 38 abuts the end of the piston channel 40), the piston 12 cannot move further down the skirt 34 without deforming the skirt.

In the example shown, a small rounded convexity (with complementary concavity on the opposite side of the skirt), referred to herein as an “inner bump” 44, is formed in the lower portion of the skirt 34. Because the inner bump 44 is formed on a part of the skirt 34 that slopes radially inwardly and upwardly toward the upper flange, it is higher on the holder 10, relative to the axial dimension, than is the bottom elbow 36.

With the above-described combination of structure, it may readily be appreciated that while FIG. 3 shows the holder 10 in its undeformed configuration for exposition purposes, as can be seen looking at the part (shown in phantom) of the diaphragm 24 that extends under the elbow 36 and skirt 34, in actuality the holder 10, after assembly, is slightly deformed by the diaphragm 24 such that the elbow 36 rests on the top surface of the diaphragm 24 and the inner bump 44 likewise rests on the upper surface of the diaphragm. However, it will be appreciated that there is less stress on and hence less deformation at the inner bump 44 than on the elbow 36 owing to the higher placement on the body 10 of the inner bump 44 compared to the elbow 36. Because the inner bump 44 is positioned radially closer to the part of the diaphragm 24 that deflects than is the elbow 36, most of the stress on the diaphragm 24 advantageously is on the non-moving part of the diaphragm that is pinched between the elbow 36 and the sensor body 20.

Furthermore, owing to the flared configuration of the upper flange 32 and the stronger, less deformable configuration afforded by the elbow 36 and angled orientation of the lower part of the skirt 34 with inner bump 44, when the cover 18 is engaged with the body 20 most of the stacked-up assembly tolerances advantageously are absorbed by the flange 32, to minimize the risk of exceeding the positional tolerance of the piston 12 relative to the diaphragm 24.

While the particular PISTON HOLDER FOR PRESSURE SWITCH ASSEMBLY is herein shown and described in detail, it is to be understood that the subject matter which is encompassed by the present invention is limited only by the claims.

What is claimed is:

1. A piston holder for a vehicle sensor including a diaphragm deflectable under fluid pressure to move a piston, comprising:
a unitary body formed in an undeformed configuration with:
a generally cylindrical outer body portion configured for surrounding the piston and having:
an open upper end circumscribed by an outwardly-flared flange; and
a rounded annular elbow opposite the flange for contacting the diaphragm; and
an annular skirt extending from the elbow, the skirt including:
a first portion oriented radially inwardly and upwardly toward the flange at an oblique angle to a vertical dimension defined by the outer body portion;
an inner bump formed in the first portion for establishing a contact point with the diaphragm at least part of the time the holder is deformed; and
a second portion extending from the first portion and oriented substantially parallel to the axial dimension for engaging a channel of the piston.

2. The holder of claim 1, wherein the second portion of the skirt abuts an end of the channel, part of the piston resting on a surface of the second portion.

3. A pressure switch assembly, comprising:
a housing disposable in a fluid;
an opening in the housing, the opening being in fluid communication with the fluid when the housing is disposed therein;
a diaphragm juxtaposed with the opening and deflectable by fluid pressure;
a piston disposed adjacent the diaphragm;
a spring urging the piston toward the opening; and
a holder supporting at least part of the piston and formed with an elbow resting on the diaphragm, the holder being formed with an annular skirt at least a portion of which extends radially inwardly and upwardly from a bottom rounded elbow of the holder, the elbow establishing a primary contact point with the diaphragm, a convexity being formed in the skirt to establish a secondary contact point with the diaphragm when the holder is slightly deformed during assembly.

4. The assembly of claim 3, wherein the skirt is formed with a substantially vertical upper segment extending from the portion of the skirt which extends radially inwardly and upwardly from the elbow, the upper segment mating with an annular channel of the piston.

5. The assembly of claim 3, wherein the holder defines an upper outwardly-flared flange.

6. The assembly of claim 3, wherein an inside surface of the portion of the skirt which extends radially inwardly and upwardly from the elbow establishes a stop against which a part of the piston rests.

7. The assembly of claim 3, wherein the convexity is closer to the upper flange than is the elbow in the axial dimension defined by the annular skirt.

8. The assembly of claim 5, wherein owing to the flared configuration of the upper flange and stronger, less deformable configuration afforded by the elbow and angled orientation of the portion of the skirt which extends radially inwardly and upwardly from the elbow, with convexity, substantially more assembly tolerances are absorbed by the flange than the portion of the skirt which extends radially inwardly and upwardly from the elbow.

9. A piston holder formed from a unitary deformable body comprising, in an undeformed state:
an open upper component configured for absorbing axial tolerance during assembly;
an outer generally cylindrical body component extending down from the upper component; and
a radially inner skirt, a first rounded contact point with a surface being established between the outer generally cylindrical body component and skirt, the skirt being formed with a second rounded contact point oriented closer in an axial dimension defined by the cylindrical body component to the open upper component than is the first contact point, wherein the body is deformable to cause both contact points to contact the surface simultaneously.

10. The holder of claim 9, wherein the open upper component is an outwardly-flared flange and the second contact point is established by an inner bump, the inner bump being formed on a first portion of the skirt, the first portion of the skirt extending radially inwardly and also oriented upwardly in the axial dimension.

11. The holder of claim 10, wherein the skirt is formed with a substantially vertical upper segment extending from the first portion of the skirt, the upper segment engageable with an annular channel of a piston.

12. The holder of claim 11, wherein an inside surface of the first portion of the skirt establishes a stop against which a part of the piston can rest.

13. The holder of claim 11, wherein owing to the flared configuration of the flange and stronger, less deformable configuration afforded by the contact points and angled orientation of the first portion of the skirt, substantially more assembly tolerances are absorbed by the flange than the first portion of the skirt.
